(19) United States
(12) Patent Application Publication
(10) Pub. No.: US 2013/0033424 A1
(43) Pub. Date: Feb. 7, 2013

(54) INPUT DEVICE

(71) Applicant: Daisaku SUGAWARA, Miyagi-ken (JP)

(72) Inventor: Daisaku SUGAWARA, Miyagi-ken (JP)

(73) Assignee: Alps Electric Co., Ltd., Ota-ku (JP)

(21) Appl. No.: 13/558,952

(22) Filed: Jul. 26, 2012

(30) Foreign Application Priority Data
Aug. 3, 2011 (JP) 2011-169802

(51) Int. Cl. G09G 5/08; G09G 5/00

(52) U.S. Cl. 345/157; 345/156

(57) ABSTRACT

An input device of the present disclosure includes reaction force map creation means for creating a reaction force map including a plurality of reaction force components corresponding to a plurality of input components displayed on a screen, and reaction force transmission means for transmitting a reaction force to an operation body when, in accordance with an operation of selecting each input component with the operation body, the corresponding reaction force component on the reaction force map is selected. When converting a screen display image into the reaction force map, the reaction force map creation means rearranges each reaction force component on the reaction force map differently from a component arrangement on the screen display image.

### CLAIM OF PRIORITY

This application contains subject matter related to and claims the benefit of Japanese Patent Application No. 2011-169802 filed on Aug. 3, 2011, the entire contents of which is incorporated herein by reference.

### BACKGROUND OF THE DISCLOSURE

1. Field of the Disclosure

The present disclosure relates to an input device that allows a reaction force to be transmitted to an operation body when a selection operation is performed on a plurality of input components arranged on a screen display.

2. Description of the Related Art

For example, a configuration is known in which, in a car navigation device, a selection operation is performed by remote control on each input component displayed on a screen and a haptic feedback device is used on the operation side to transmit a reaction force to a finger via an operation body when the input component is selected.

FIG. 11A schematically shows a screen display image, and FIG. 11B schematically shows a reaction force map in the related art.

The screen display image 1 shown in FIG. 11A represents a screen displayed on a screen display device, and a plurality of input components 2 to 5 are arranged as shown in FIG. 11A.

Reaction force components 7 to 10 arranged in the existing reaction force map 6 as shown in FIG. 11B have the same arrangement as the input components 2 to 5 in the screen display image 1 shown in FIG. 11A.

When, through an operation of the operation body by the haptic feedback device, for example, the input component 2 on the screen is selected and the reaction force component 7 corresponding to the input component 2 is selected on the reaction force map 6, a reaction force is transmitted to a finger via the operation body of the haptic feedback device, and thus it can be determined that the input component 2 has been selected, without seeing the screen.

There are problems with the reaction force map 6 shown in FIG. 11B For example, it is assumed that a pointer 11 on the screen display image 1 is located near the lower right of the screen as shown in FIG. 11A. Meanwhile, also on an absolute coordinate map of the reaction force map 6, a pointer 12 is located at the same coordinate as the pointer 11. When the pointer 11 is moved to the upper side of the screen through an operation of the operation body, the pointer 12 on the reaction force map 6 also moves similarly.

When the pointer 11 is located near the lower right of the screen as shown in FIG. 11A, the pointer 11 has to be operated to move to the upper side of the screen by a certain distance in order to select the input components 2 to 5. Thus, the operation becomes troublesome and it takes time to select the input components 2 to 5, resulting in a shift of operator's attention to a pointer operation.

Therefore, for example, when control is performed to initially focus on the input component 5 closest to the current position of the pointer 11, a pointer operation can easily be performed.

However, even when the input component 5 on the screen is focused on, the pointer 12 still remains located near the lower right of the absolute coordinate map of the reaction force map 6 in FIG. 11B. Even with a later pointer operation for performing a selection operation on each of the input components 2 to 5, the pointer 12 moves on the reaction force map 6 in a region different from regions of the reaction force components 7 to 10. Therefore, even when the input component is focused on, no reaction force occurs. Or, a defect, such as a deviation of timing at which a reaction force occurs from timing at which the input component is focused on, occurs.

Japanese Unexamined Patent Application Publication No. 2010-176426 discloses an input control device for controlling troublesome drawing-in in a path on which a pointer is moved.

However, in Japanese Unexamined Patent Application Publication No. 2010-176426, the problem with the fact that the component arrangements on the screen display image 1 and the reaction force map 2 shown in FIGS. 11A and 11B are the same is not taken into account.

These and other drawbacks exist.

### SUMMARY OF THE DISCLOSURE

The various embodiments of the present disclosure solve the problems described above and in particular provide an input device in which component arrangements on a screen display image and a reaction force map are made different from each other to improve operability as compared to the related art.

The present disclosure provides an input device including: reaction force map creation means for creating a reaction force map including a plurality of reaction force components corresponding to a plurality of input components displayed on a screen; and reaction force transmission means for transmitting a reaction force to an operation body when, in accordance with an operation of selecting each input component with the operation body, the corresponding reaction force component on the reaction force map is selected. When converting a screen display image into the reaction force map, the reaction force map creation means rearranges each reaction force component on the reaction force map differently from a component arrangement on the screen display image.

As described above, in the present disclosure, the component arrangement is made different between the screen display and the reaction force map. Thus, a defect such as a reaction force not being generated even when an input component on the screen display is selected as in the related art, does not occur, and an input device having excellent operability can be configured.

In the present disclosure, a map occupancy of each reaction force component may be made larger than a screen occupancy of each input component. In this case, the reaction force components may be rearranged so as to occupy a substantially entire area of the reaction force map.

Further, the reaction force components on the reaction force map may be rearranged on the basis of a current position of a pointer moving on an absolute coordinate map by an operation of the operation body. In this case, the reaction force components may be arranged around the current position of the pointer.

Further, the reaction force components may be rearranged within a limited region in the reaction force map. Each reaction force component may be created in an outer shape different from that of the input component corresponding to the reaction force component.

The reaction force components also may be arranged so as to be closer to each other than the input components. And control may be performed so as to initially focus on any input component located at distant from a current position of a non-displayed first pointer on the screen; on the reaction force map, a second pointer may be located on an absolute coordinate map and at a substantially same coordinate as the current position of the first pointer; and the reaction force components may be rearranged such that the reaction force component corresponding to the focused input component overlaps the second pointer. In this case, the initially focused input component may be the input component located closest to the current position of the first pointer.

Further, when converting the screen display image into the reaction force map, the reaction force map creation means may perform component search in a screen vertical direction or in a screen horizontal direction, and may rearrange the reaction force components on the reaction force map on the basis of a result of the search.

In the above, on the basis of component search in the vertical direction or in the horizontal direction, a plurality of groups may be created and component arrangement may be performed for each group. In addition, the reaction force components may be allocated uniformly in accordance with the number of the components for each group.

In addition, component arrangement may be performed with an intermediate position between each group as a boundary.

Further, in the present invention, the input device may include a screen display device, a haptic feedback device including the operation body and the reaction force transmission means, and a device body connected between the screen display device and the haptic feedback device and capable of performing transmission/reception of information therebetween, and the reaction force map creation means may be provided in the device body or the haptic feedback device.

### BRIEF DESCRIPTION OF THE DRAWINGS

FIG. 1 is a configuration diagram of an input device according to an exemplary embodiment wherein a reaction force map creation means is provided within a device body (car navigation device);

FIG. 2 is a configuration diagram of an input device according to an examplary embodiment wherein a reaction force map creation means is provided within a haptic feedback device;

FIG. 3A is a schematic diagram showing a screen display image according to an exemplary embodiment of the disclosure;

FIG. 3B is a schematic diagram showing an exemplary embodiment of a reaction force map for the screen display image in FIG. 3A;

FIG. 4A is a schematic diagram showing a screen display image according to an exemplary embodiment of the disclosure;

FIG. 4B is a schematic diagram showing an exemplary embodiment of a reaction force map for the screen display image in FIG. 4A;

FIG. 5A is a schematic diagram showing a screen display image according to an exemplary embodiment of the disclosure;

FIG. 5B is a schematic diagram showing an exemplary embodiment of a reaction force map for the screen display image in FIG. 5A;

FIG. 6A is a schematic diagram showing a screen display image according to an exemplary embodiment of the disclosure;

FIG. 6B is a schematic diagram showing an exemplary embodiment of a reaction force map for the screen display image in FIG. 6A;

FIG. 7A a schematic diagram showing a screen display image according to an exemplary embodiment of the disclosure;

FIG. 7B is a schematic diagram showing an exemplary embodiment of a reaction force map for the screen display image in FIG. 7A;

FIG. 8A is a schematic diagram showing the same screen display image as in FIG. 7A;

FIG. 8B is a schematic diagram showing an exemplary embodiment of a reaction force map obtained by changing the arrangement of each reaction force component from FIG. 7B;

FIG. 9A is a schematic diagram showing the same screen display image as in FIG. 3A;

FIG. 9B is a schematic diagram showing an exemplary embodiment of a reaction force map for the screen display image in FIG. 9A;

FIG. 9C is a schematic diagram showing the same screen display image as in FIG. 5A;

FIG. 9D is a schematic diagram showing an exemplary embodiment of a reaction force map for the screen display image in FIG. 9C;

FIG. 10A is a schematic diagram showing the same screen display image as in FIG. 3A;

FIGS. 10B and 10C are schematic diagrams each showing an exemplary embodiment of a reaction force map for the screen display image in FIG. 10A;

FIG. 11A is a schematic diagram showing a screen display image; and

FIG. 11B is a schematic diagram showing a reaction force map in the related art.

### DESCRIPTION OF THE PREFERRED EMBODIMENTS

The following description is intended to convey a thorough understanding of the embodiments described by providing a number of specific embodiments and details involving an input device. It should be appreciated, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending on specific design and other needs.

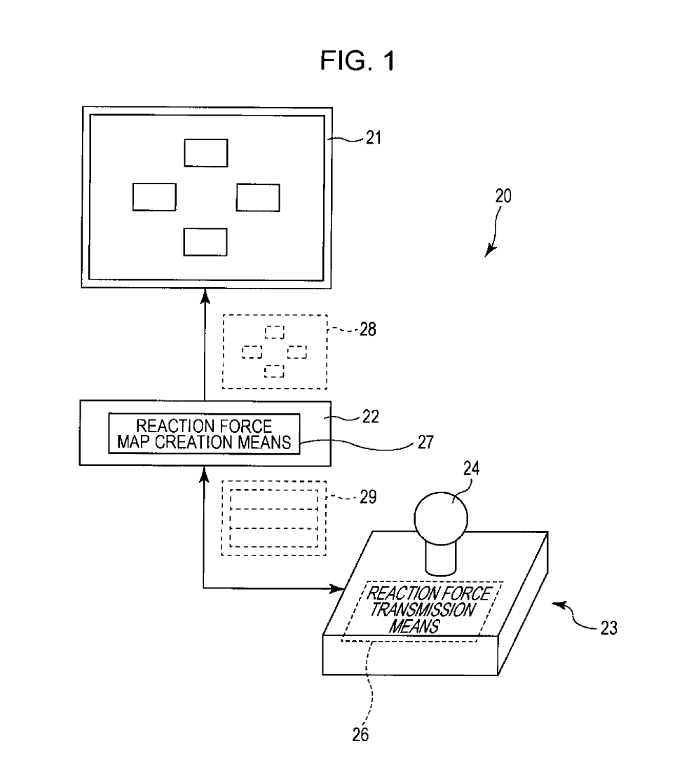

FIG. 1 is a configuration diagram (schematic diagram) of an input device according to an embodiment. FIG. 1 shows a car navigation device 20 as a typical example among screen display type input devices such as a car navigation device. The car navigation device 20 may include a screen display device 21, a car navigation body (device body) 22, and a haptic feedback device 23 capable of remotely controlling the car navigation body 22. The car navigation body 22 may perform transmission/reception of information between the screen display device 21 and the haptic feedback device 23.

As shown in FIG. 1, the haptic feedback device 23 may be disposed, for example, at a center console in a vehicle and may be configured such that a driver can operate an operation body 24 of the haptic feedback device 23. The operation body 24 may be, for example, a joystick type, but the configuration of the operation body 24 is not particularly limited to a specific configuration. A cross operation, a multi-directional operation, an analogue operation, and the like can be performed on the operation body 24.

As shown in FIG. 1, a reaction force transmission means 26 may be provided in the haptic feedback device 23. In various exemplary embodiments, reaction force transmission means may include a reaction force transmitter, for example.

In the embodiment shown in FIG. 1, a reaction force map creation means 27 may be provided in the car navigation body 22. In other words, in the car navigation body 22, a screen display image 28 may be converted into a reaction force map 29 by a reaction force map converter, for example.

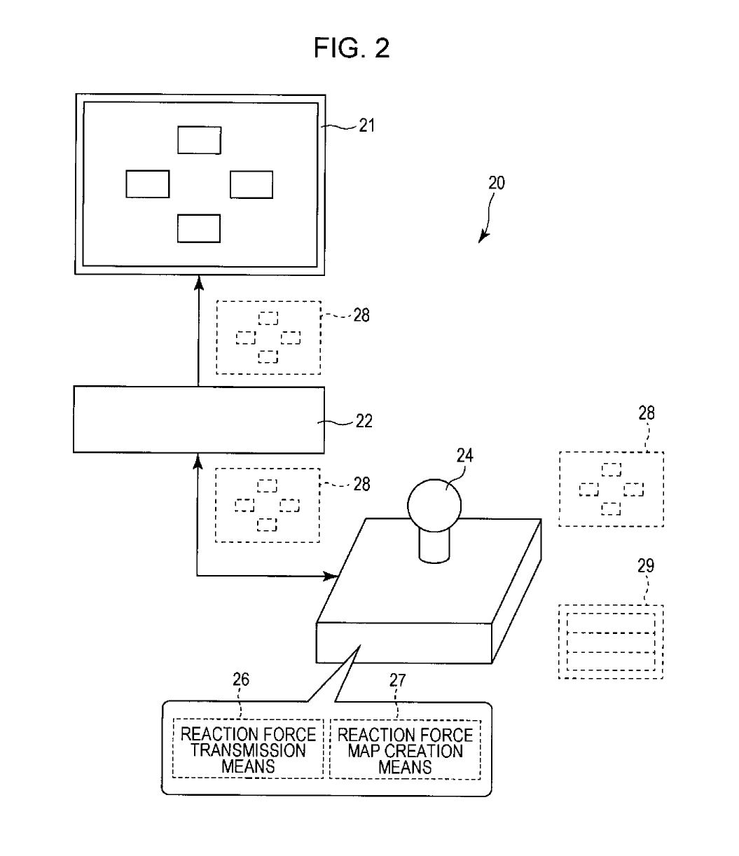

Also, as shown in FIG. 2, the reaction force map creation means 27 may be provided in the haptic feedback device 23, and it also may be possible to convert the screen display image 28 transmitted from the car navigation body 22 into the reaction force map 29 in the haptic feedback device 23.

In the car navigation body 22, control may be performed such that the screen display image 28 is displayed on the screen display device 21.

In addition, in the haptic feedback device 23, control may be performed such that a reaction force is transmitted to the operation body 24 by the reaction force transmission means 26 on the basis of the reaction force map 29 created in the car navigation body 22 or the haptic feedback device 23.

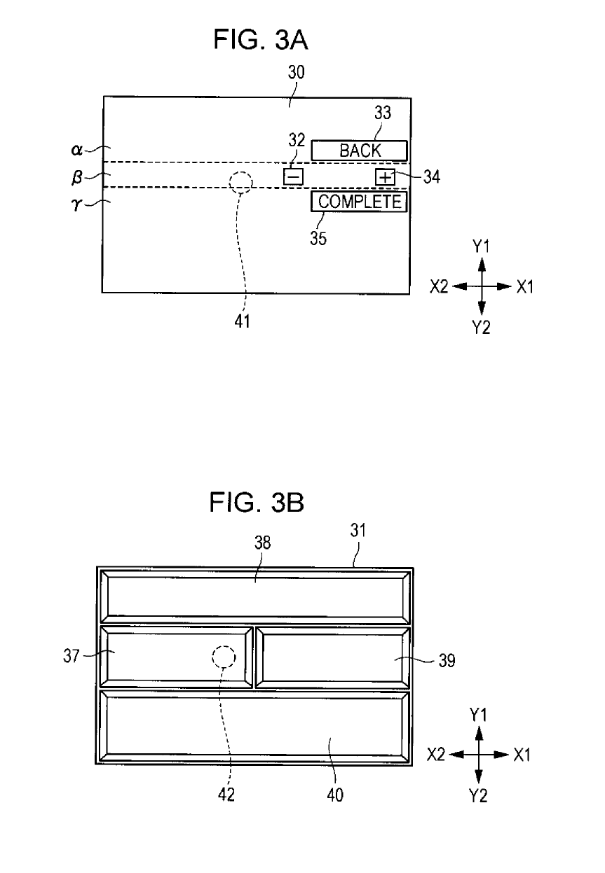

FIG. 3A is a schematic diagram showing a screen display image 30, and FIG. 3B is a schematic diagram showing an embodiment of a reaction force map 31 for the screen display image 30 in FIG. 3A.

As shown in FIG. 3A, a plurality of input components 32 to 35 may be arranged on the screen display image 30. The screen display image 30 may be displayed on the screen display device 21 shown in FIGS. 1 and 2. On the screen, “−” may be displayed in the input component 32, “BACK” is displayed in the input component 33, “+” is displayed in the input component 34, “COMPLETE” is displayed in the input component 35. The +“−”, “+”, “BACK”, and “COMPLETE” may indicate, for example, button functions on the screen display device 21.

In such an embodiment, the reaction force map creation means 27 shown in FIGS. 1 and 2 may convert the screen display image 30 shown in FIG. 3A into the reaction force map 31 shown in FIG. 3B. As shown in FIG. 3B, reaction force components 37 to 40 on the reaction force map 31 may be rearranged differently from the component arrangement on the screen display image 30. As shown in FIG. 3B, the reaction force components 37 to 40 on the reaction force map 31 may be displayed as buttons, but this is an image.

The map sizes of the screen display image 30 and the reaction force map 31 may be substantially the same in vertical (Y)-to-horizontal (X) ratio, and the screen display image 30 and the reaction force map 31 may be shown in the substantially same map size in FIG. 3A and the subsequent drawings. Thus, in the following, the sizes of the reaction force components 37 to 40 on the reaction force map 31 and the input components 32 to 35 on the screen display image 30 and comparison of the intervals between the components may be evaluated by the absolute sizes shown in the drawings, but may be evaluated by map occupancy (an occupation area ratio or a length ratio in the map) in the case where the map sizes are different.

The reaction force component 37 shown in FIG. 3B corresponds to the input component 32 shown in FIG. 3A; the reaction force component 38 shown in FIG. 3B corresponds to the input component 33 shown in FIG. 3A; the reaction force component 39 shown in FIG. 3B corresponds to the input component 34 shown in FIG. 3A; and the reaction force component 40 shown in FIG. 3B corresponds to the input component 35 shown in FIG. 3A.

As shown in FIG. 3B, the reaction force components 37 to 40 may be formed so as to be large as compared to the input components 32 to 35 to occupy the substantially entire area on the reaction force map 31 and so as to change the vertical-to-horizontal ratios from those of the input components 32 to 35 to have different outer shapes.

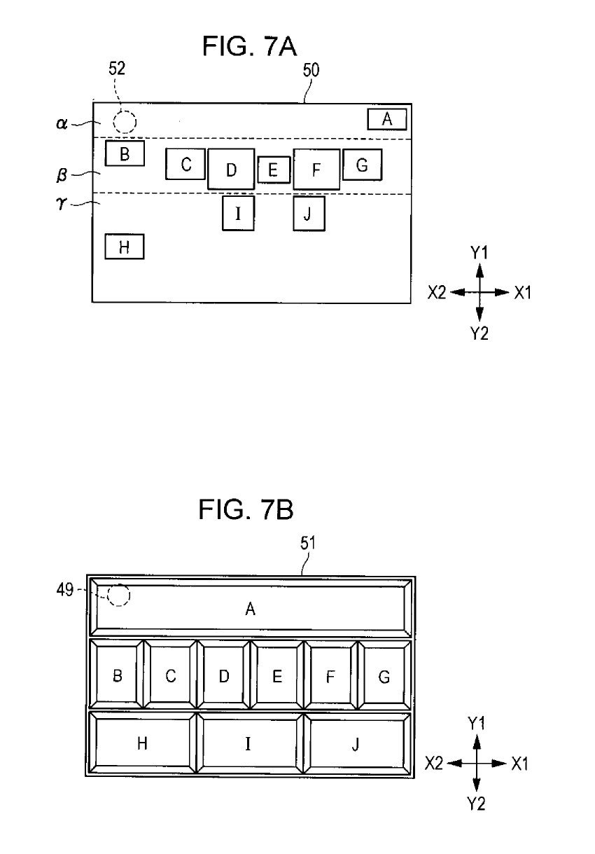

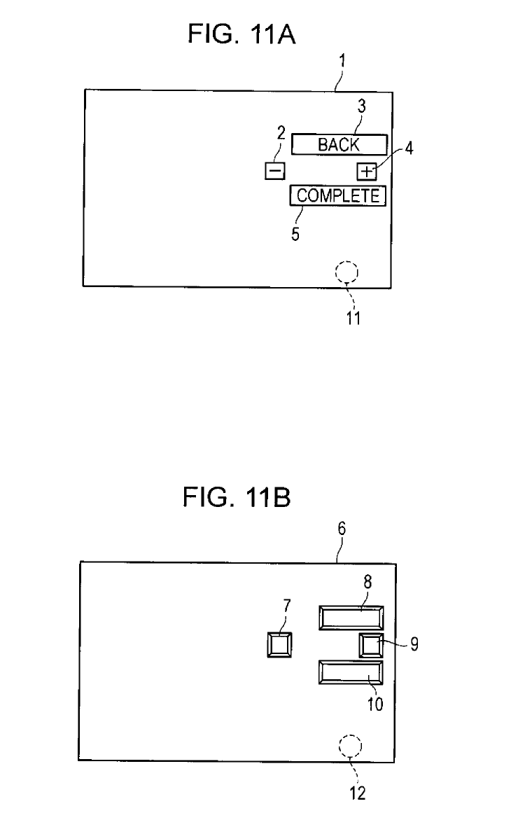

There are various methods for converting the screen display image 30 into the reaction force map 31, and the method is not particularly limited to a specific method. However, for example, the reaction force map creation means 27 may search for the input components 32 to 35 arranged in the screen display image 30 shown in FIG. 3A, in the vertical direction (Y1-Y2), or the reaction force map creation means 27 may create a reaction force map 6 having the same component arrangement as in the related art shown in FIG. 11B, from the screen display image 30 in FIG. 3A, and then may search for each reaction force component arranged in the reaction force map 6, in the vertical direction (Y1-Y2) to divide each component into a plurality of vertical groups α, β, and γ. Group formation will be described with the screen display image 30 in FIGS. 3A and 3B and also in FIGS. 7A to 9D described later. In the embodiment of FIGS. 3A and 3B, the vertical groups α, β, and γ may be allocated uniformly with respect to the length of the reaction force map 31 in the vertical direction (Y1-Y2), and the components within the vertical groups α, β, and γ may be uniformly allocated in accordance with the number of the components arranged within the vertical groups α, β, and γ, whereby the reaction force map 31 shown in FIG. 3B can be created.

Now, it is assumed that a first pointer 41 is located substantially at the center on the screen display image 30 as shown in FIG. 3A. The first pointer 41 may be, for example, non-displayed on the screen display device 21 (see FIGS. 1 and 2). At that time, on an absolute coordinate map of the reaction force map 31 shown in FIG. 3B, a second pointer 42 may be located at the same coordinate position as the first pointer 41, namely, substantially at the center on the reaction force map 31.

As shown in FIG. 3A, on the screen display image 30, the first pointer 41 may be distant from the input components 32 to 35, and, for example, control may be performed in the car navigation body 22 to initially focus on the first input component 32 closest to the current position of the first pointer 41. Then, for example, when a cross operation is performed on the operation body 24 to operate the operation body 24 in the right direction (X1) from the state in which the input component 32 is initially focused on, the input component 34 can be focused on from the input component 32 on the screen. At that time, as shown in FIG. 3B, the second pointer 42 on the reaction force map 31 may be located on the reaction force component 37 corresponding to the input component 32 and may move in the rightward direction (X1) with the operation of the operation body 24, and the reaction force component 39 can be selected from the reaction force component 37. When the operation body 24 is operated in the Y1 direction from the state in which the input component 32 is initially focused on, the input component 33 can be focused on from the input component 32 on the screen. At that time, the second pointer 42 on the reaction force map 31 also may move in the Y1 direction, and the reaction force component 38 can be selected from the reaction force component 37. Moreover, when the operation body 24 may be operated in the Y2 direction from the state in which the input component 32 is initially focused on, the input component 35 can be focused on from the input component 32 on the screen. At that time, the second pointer 42 on the reaction force map 31 also may move in the Y2 direction, and the reaction force component 40 can be selected from the reaction force component 37.

As described above, when each of the input components 32 to 35 is focused on, each of the reaction force components 37 to 40 corresponding to the input components 32 to 35 may be appropriately selected also on the reaction force map 31. Thus, in the haptic feedback device 23, a reaction force can be generated in accordance with the focusing on the input component.

As described above, since the reaction force components 37 to 40 on the reaction force map 31 may be rearranged differently from the component arrangement on the screen display image 30, occurrence of a defect such as a reaction force not being generated even when the input components 32 to 35 are selected as in the related art, can be suppressed, and an input device having excellent operability can be configured.

Further, since the reaction force components 37 to 40 on the reaction force map 31 may be rearranged as shown in FIG. 3B, it is possible to design a crisp feel between each reaction force component and a drawing-in coordinate as intended.

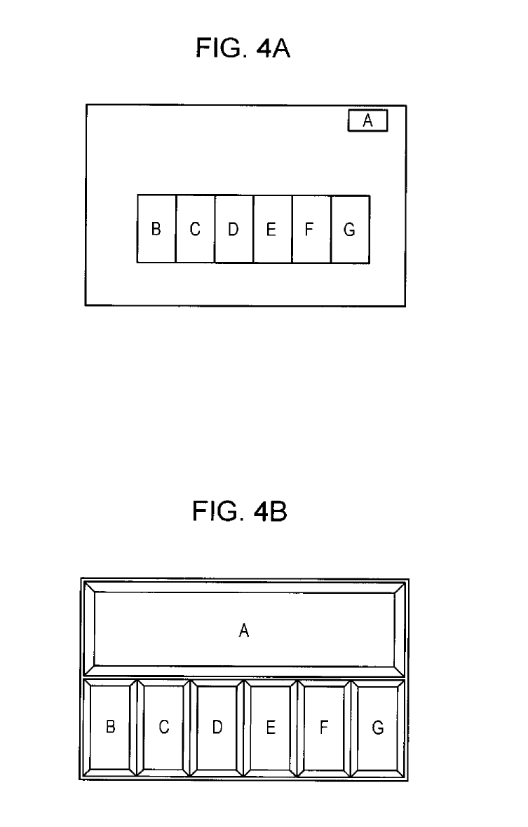

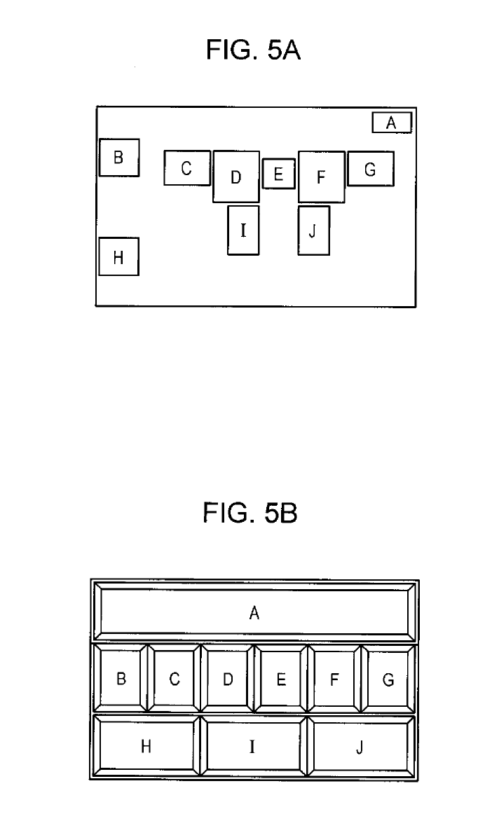

FIGS. 4A, 5A, and 6A are schematic diagrams showing screen display images, and FIGS. 4B, 5B, and 6B are schematic diagrams each showing an embodiment of a reaction force map. Input components A to J shown in FIGS. 4A, 5A, and GA correspond to reaction force components A to J shown in FIGS. 4B, 5B, and 6B.

Similarly to FIG. 3B, in the reaction force maps shown in FIGS. 4B, 5B, and 6B, the reaction force components A to J may be formed so as to be larger than the corresponding input components A to J and may be arranged in the substantially entire surface of the map.

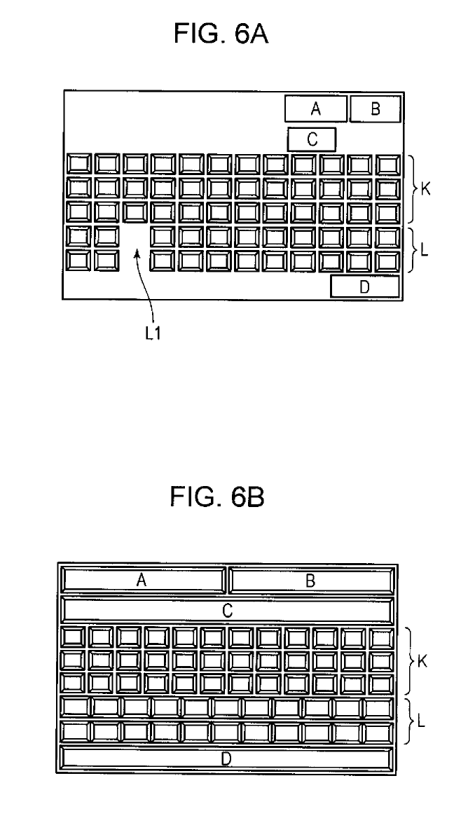

In FIG. 6A, there may be 50-character input components around the center of the screen, a component row K may be configured to be substantially the same as a component row K on the reaction force map in FIG. 6B. However, in a component row L on the display screen image shown in FIG. 6A, there may be a space L₁ in which no component is present, and, on the reaction force map in FIG. 6B, the size of each component constituting a component row L may be made horizontally longer than that on the screen display image in FIG. 6A so as to occupy the space L₁.

FIG. 7A is a schematic diagram showing a screen display image, and FIG. 7B is a schematic diagram showing one embodiment of a reaction force map for the screen display image in FIG. 7A, in particular, a reaction force map obtained by searching for input components A to J arranged on a screen display image 50 in the vertical direction (Y1-Y2) and rearranging reaction force components A to J on the basis of the search result. In other words, the input components A to J may be searched for in the vertical direction and divided into a plurality of vertical groups α, β, and γ. For example, the vertical groups α, β, and γ may be allocated uniformly with respect to the length of the reaction force map 51 in the vertical direction (Y1-Y2), and the reaction force components within the vertical groups α, β, and γ may be allocated uniformly in the horizontal direction (X1-X2) in accordance with the number of the components arranged within the vertical groups α, β, and γ, whereby the reaction force map 51 shown in FIG. 7B can be created.

When a first pointer 52 on the screen is located near the upper left as shown in FIG. 7A, the input component A may be initially focused on. On the reaction force map 51 in FIG. 7B as well, a second pointer 49 may be located on a reaction force component A corresponding to the input component A.

When a pointer operation is performed in the Y2 direction from this state, the operator thinks that the input component G closest to the currently focused input component A is focused on. However, when the second pointer 49 moves on the reaction force map 51 in the Y2 direction, the reaction force component B is selected.

In the case where an operation gap occurs between the screen display image 50 and the reaction force map 51 to provide an uncomfortable feel to the operator as described above, it may be necessary to change the method for converting the screen display image into the reaction force map.

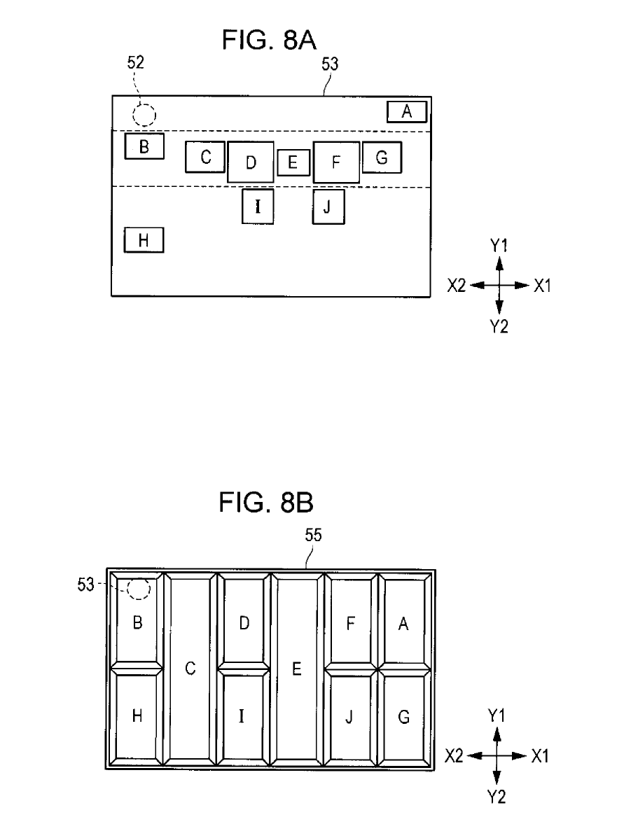

That is, as shown in FIG. 8A, for example, the input component A to J may be searched for in the horizontal direction (X1-X2) and divided into a plurality of horizontal groups a to f. The horizontal groups a to f may be allocated uniformly with respect to the length of a reaction force map 53 in the horizontal direction (X1-X2), and the reaction force components within the horizontal groups a to f may be allocated uniformly in the vertical direction (Y1-Y2) in accordance with the number of the components arranged within the horizontal groups a to f, whereby a reaction force map 55 shown in FIG. 8B can be created.

Because of this, when the input component B closest to the first pointer 52 on the screen is focused on, the reaction force map 53 also may be caused to come into a state in which the reaction force component B corresponding to the input component B is selected as shown in FIG. 8B. Then, when the operator operates the pointer in the Y2 direction to focus on the input component H from the input component B, the second pointer 49 also may move on the reaction force map 55 to select the reaction force component H, and a reaction force occurs on the basis of the selection of the reaction force component H. Thus, the operator is less likely to feel uncomfortable than in the configuration of FIG. 7, resulting in improvement of the operability.

Optimal reaction force map conversion processing depends on the layout of each input component on the screen display image, the pointer position, or the like. Thus, it may be necessary to perform optimal reaction force map conversion processing. Control may be performed such that the reaction force maps 51 and 55 in FIGS. 7B and 8B or other reaction force maps can be switched according to the component layout or the pointer position or by the operator. It should be noted that the above-described conversion processing based on the screen layout, the pointer position, or the like is preferably performed in the car navigation body having screen layout information, that is, the car navigation body 22 preferably has the reaction force map creation means 27 as shown in FIG. 1.

In the above, each vertical group and each horizontal group may be uniformly allocated within the reaction force maps, and the components may be uniformly allocated within each group in accordance with the number of the components. However, each component can be allocated differently from the above.

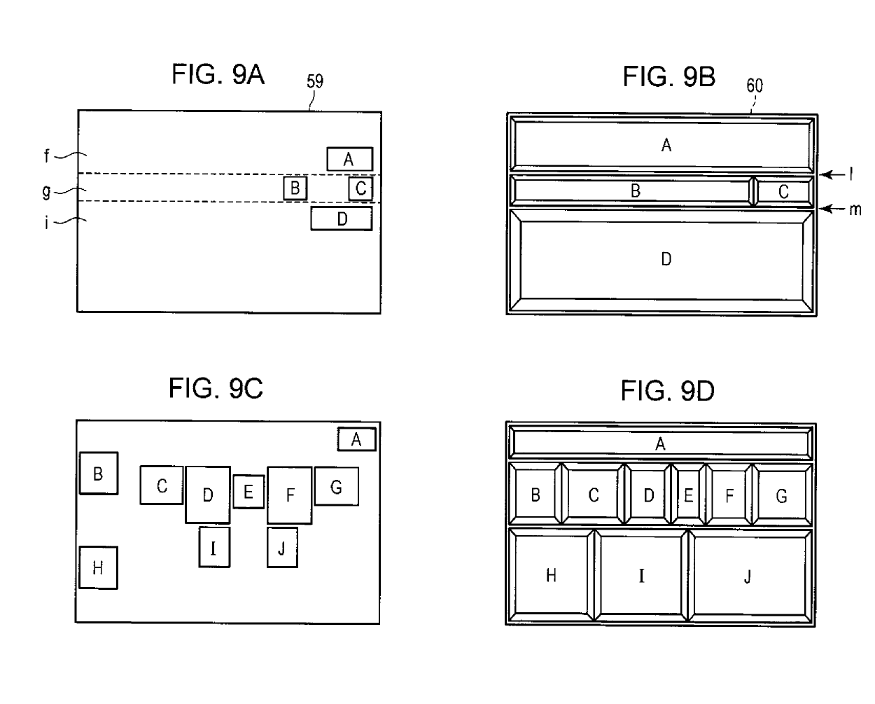

In FIG. 9A, input components A to D may be searched for in the vertical direction (Y1-Y2) and divided into a plurality of vertical groups f to i. Here, reaction force components A to D may be arranged with the intermediate position j between the vertical group f and the vertical group g and the intermediate position k between the vertical group g and the vertical group i as boundaries. In other words, the boundary l between the reaction force component A and the reaction force components B and C on a reaction force map 60 in FIG. 9B may be located on the same line as the intermediate position j in the screen display image 59, and the boundary m between the reaction force components B and C and the reaction force component D on the reaction force map 60 may be located on the same line as the intermediate position k in the screen display image 59. The two input components B and C may be arranged in the vertical group g as shown in FIG. 9A, and the reaction force components B and C on the reaction force map 60 may be arranged with the intermediate position n between the input components B and C in the horizontal direction (X1-X2) as a boundary therebetween.

Reaction force components A to J on a reaction force map 62 in FIG. 9D also may be rearranged from a screen display image 61 in FIG. 9C in the same manner as the conversion processing between FIGS. 9A and 9B.

Control may be performed such that when creating a reaction force map, the conversion processing in FIGS. 9A to 9D is used if the operability is more excellent with the component arrangement in which the components are allocated with the intermediate position between each group as a boundary and the intermediate position between each reaction force component within each group as a boundary as shown in FIGS. 9A to 9D than with the component arrangement in which the groups and the reaction force components within each group may be uniformly allocated as shown in FIGS. 3A and 3B and FIGS. 8A and 8B, or such that a plurality of conversion processing including the conversion processing in FIGS. 9A to 9D is selectable.

In both FIGS. 3A and 3B and FIGS. 9A to 9D, each reaction force component may be formed on the substantially entirety of the reaction force map, but each reaction force component can be rearranged within a limited region on the reaction force map.

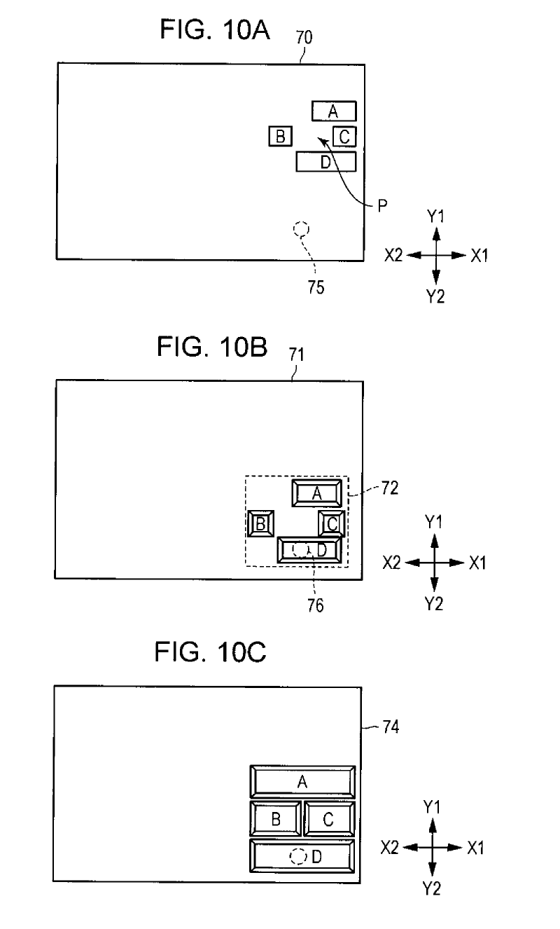

FIG. 10A is a schematic diagram showing the same screen display image as in FIG. 3A, and FIGS. 10B and 10C are schematic diagrams each showing one embodiment of a reaction force map for the screen display image in FIG. 10A. When converting a screen display image 70 in FIG. 10A into a reaction force map 71 in FIG. 10B, a group 72 of reaction force components A to D is moved in the Y2 direction from that on the screen display image 70 in FIG. 10A. The reaction force components A to D shown in FIG. 10B are not changed in size and shape from the input components A to D in FIG. 10A and the intervals between the input components A to D are also not changed. However, the movement of the component group on the map from FIG. 10A to FIG. 10B may be one configuration obtained by rearranging each reaction force component differently from the component arrangement on the screen display image.

As shown in FIG. 10A, a first pointer 75 may be located near the lower right of the screen display image 70. When converting the screen display image 70 into the reaction force map 71 in FIG. 10B, the reaction force components A to D may be rearranged on the basis of the current position of a second pointer 76 on the map at the same coordinate position as the first pointer 75. At that time, when control is performed so as to initially focus on the input component D closest to the first pointer 75 on the screen display image 70, the group 72 of the reaction force components A to D may be rearranged such that the reaction force component D overlaps the second pointer 76 as shown in FIG. 10B.

Because of this, when, for example, a cross operation is performed on the operation body from the initially focused input component D to focus on each of the input components A to C on the screen, the second pointer 76 on the reaction force map 71 also may move on the basis of the operation of the operation body, and each of the reaction force components A to C can be selected. Thus, it can be configured that a reaction force appropriately occurs when focusing on each of the input components A to D.

For example, in FIGS. 3A and 3B, the reaction force components 37 to 40 on the reaction force map 31 may be formed so as to be large as compared to the input components 32 to 35 on the screen display image 30, and occupy the substantially entire area of the reaction force map 31. Thus, when the operability slightly deteriorates since a certain operation distance is required to move the second pointer 42 on the reaction force map 31 shown in FIG. 3B onto each of the reaction force components 37 to 40, or when the cost increases since pointer movement control is required, each reaction force component on the reaction force map 71 can be provided within the limited region as shown in FIG. 10B to improve the operability.

In addition, on a reaction force map 74 in FIG. 10C as well, reaction force components A to D are formed within a limited region in the reaction force map 74. It should be noted that in FIG. 10C, the reaction force components A to D may be formed so as to be slightly larger than the input components A to D on the screen display image 70. A space P may be present between the input component B and the input component C on the screen display image 70, but the gap between the reaction force component B and the reaction force component C on the reaction force map 74 may be made sufficiently smaller than the space P. Since the gap between the reaction force component B and the reaction force component C is reduced, a movement distance of the pointer between the reaction force component B and the reaction force component C can be small, and a reaction force can be quickly generated when switching between the reaction force component B and the reaction force component C.

When a reaction force map is formed within a limited region, it also may be effective to form a reaction force on a wall so as to surround all the components. Thus, even when the operator performs an operation in a wrong direction, the operation can be prevented from being out of the region in which the reaction force is formed.

The input device in the embodiment is not limited to one for use in a vehicle, but is effective when used in a vehicle, since the operator can recognize that each input component has been selected, through vibrations via the operation body 24 without seeing the screen display device 21.

When the haptic feedback device 23 is configured to have the reaction force transmission means 26 and the reaction force map creation means 27 as shown in FIG. 2, the minimum unit of the “input device” in the present disclosure is the haptic feedback device 23. When the reaction force map creation means 27 is included in the car navigation body 22 as shown in FIG. 1, the car navigation device 20 that includes the haptic feedback device 23, the car navigation body 22, and the screen display device 21 corresponds to the “input device” of the present disclosure.

Accordingly, the embodiments of the present inventions are not to be limited in scope by the specific embodiments described herein. Further, although some of the embodiments of the present disclosure have been described herein in the context of a particular implementation in a particular environment for a particular purpose, those of ordinary skill in the art should recognize that its usefulness is not limited thereto and that the embodiments of the present inventions can be beneficially implemented in any number of environments for any number of purposes. Accordingly, the claims set forth below should be construed in view of the full breadth and spirit of the embodiments of the present inventions as disclosed herein. While the foregoing description includes many details and specificities, it is to be understood that these have been included for purposes of explanation only, and are not to be interpreted as limitations of the invention. Many modifications to the embodiments described above can be made without departing from the spirit and scope of the invention.

What is claimed is:

1. An input device comprising:
reaction force map creator that creates a reaction force map including a plurality of reaction force components corresponding to a plurality of input components displayed on a screen; and
reaction force transmitter that transmits a reaction force to an operation body when, in accordance with an operation of selecting each input component with the operation body, the corresponding reaction force component on the reaction force map is selected, wherein
when converting a screen display image into the reaction force map, the reaction force map creator rearranges each reaction force component on the reaction force map differently from a component arrangement on the screen display image.

2. The input device according to claim 1, wherein a map occupancy of each reaction force component is made larger than a screen occupancy of each input component.

3. The input device according to claim 2, wherein the reaction force components are rearranged so as to occupy a substantially entire area of the reaction force map.

4. The input device according to claim 1, wherein the reaction force components on the reaction force map are rearranged on the basis of a current position of a pointer moving on an absolute coordinate map by an operation of the operation body.

5. The input device according to claim 4, wherein the reaction force components are arranged around the current position of the pointer.

6. The input device according to claim 1, wherein the reaction force components are rearranged within a limited region in the reaction force map.

7. The input device according to claim 1, wherein each reaction force component is created in an outer shape different from that of the input component corresponding to the reaction force component.

8. The input device according to claim 1, wherein the reaction force components are arranged so as to be closer to each other than the input components.

9. The input device according to claim 1, wherein
control is performed so as to initially focus on any input component located at distant from a current position of a non-displayed first pointer on the screen,
on the reaction force map, a second pointer is located on an absolute coordinate map and at a substantially same coordinate as the current position of the first pointer, and
the reaction force components are rearranged such that the reaction force component corresponding to the focused input component overlaps the second pointer.

10. The input device according to claim 9, wherein the initially focused input component is the input component located closest to the current position of the first pointer.

11. The input device according to claim 1, wherein when converting the screen display image into the reaction force map, the reaction force map creator performs component search in a screen vertical direction or in a screen horizontal direction, and rearranges the reaction force components on the reaction force map on the basis of a result of the search.

12. The input device according to claim 11, wherein component arrangement is performed with an intermediate position between each group as a boundary.

13. The input device according to claim 11, wherein on the basis of component search in the vertical direction or in the horizontal direction, a plurality of groups are created and component arrangement is performed for each group.

14. The input device according to claim 13, wherein component arrangement is performed with an intermediate position between each group as a boundary.

15. The input device according to claim 13, wherein the reaction force components are allocated uniformly in accordance with the number of the components for each group.

16. The input device according to claim 15, wherein component arrangement is performed with an intermediate position between each group as a boundary.

17. The input device according to claim 1, wherein
the input device includes a screen display device, a haptic feedback device including the operation body and the reaction force transmitter, and a device body that transmits or receives transmission/reception information, respectively, between the screen display device and the haptic feedback device, and
the reaction force map creator is provided in the device body.

18. The input device according to claim 1, wherein
the input device includes a screen display device, a haptic feedback device including the operation body and the reaction force transmitter, and a device body that transmits or receives transmission/reception information, respectively, between the screen display device and the haptic feedback device, and
the reaction force map creator is provided in the haptic feedback device.
